(19) United States
(12) Patent Application Publication
(10) Pub. No.: US 2025/0155326 A1
(43) Pub. Date: May 15, 2025

(54) DEVICE FOR APPLYING FORCE TO A TEST OBJECT

(71) Applicant: Illinois Tool Works Inc., Glenview, IL (US)

(72) Inventors: Gerald JUNG, Gadernheim (DE); Alfred CLÜSSERATH, Roßdorf (DE)

(21) Appl. No.: 18/943,278

(22) Filed: Nov. 11, 2024

(30) Foreign Application Priority Data
Nov. 14, 2023 (DE) 10 2023 131 734.2

(51) Int. Cl. G01M 17/02; G01M 17/013

(52) U.S. Cl. CPC G01M 17/021; G01M 17/013

(57) ABSTRACT

The present disclosure relates to an apparatus for introducing force into a test vehicle, wherein the apparatus comprises: a wheel adapter element, which is configured so as to be connected to a test vehicle; first to third loading assemblies for moving the wheel adapter element in three translational degrees of freedom; and a fourth loading assembly for rotating the wheel adapter element about a wheel axis (A), wherein the first, second, and third loading assembly are connected to the wheel adapter element via a common three-joint node.

### RELATED APPLICATIONS

The present application claims the benefit of German (DE) patent application Ser. No. 10/202,3131734.2, filed Nov. 14, 2023. The entirety of German Patent Application No. 102023131734.2 is expressly incorporated herein by reference.

### FIELD OF THE DISCLOSURE

The present disclosure relates to an apparatus for introducing force into a test vehicle, in particular to simulate forces or torques introduced during driving operation in a motor vehicle or in parts of a motor vehicle.

### BACKGROUND

Driving dynamics, driving comfort, and driving safety are core elements in vehicle development. The chassis plays a key role in this. It has the task of supporting the vehicle mass, springing, damping vibrations and noises, compensating for external interference variables, bringing the drive torque onto the roadway, and bearing, guiding, steering, and braking the wheels. In addition to this variety of tasks, the chassis is also subjected to complex loads that the plurality of active and adaptive chassis components employed must also withstand. Increasing demands require continuous development and optimization of the chassis components, the body, and add-on parts in order to minimize the impact of roadway conditions, reduce weight and cost, and simultaneously increase lifetime and safety.

On the one hand, such influences on the chassis components can be checked by means of long-term tests (e.g., test drives). However, in order to simulate a lifecycle of a vehicle, it is necessary to test several hundred thousand miles of driving operation. This would require several months, even for continuous test drives. For the reasons mentioned above, “test benches” are used, which can replicate the forces and loads occurring in real driving operation as realistically as possible. Such test benches can simulate the forces and stresses occurring over several hundred thousand miles within a few days/weeks.

In general, at the end of an operational life-related quality assurance process, “test benches” serve to replicate the forces and loads that occur during real-world driving and that act on a vehicle to be tested or on parts of a vehicle to be tested as realistically as possible. For this purpose, real operating loads are carried out after driving tests on axial and total vehicle test benches in order to draw conclusions about the effects of certain loads, in particular on the operational strength and oscillation behavior of the vehicle.

With such test benches, studies of chassis systems can be carried out under different driving states and roadway conditions, even at an early development stage, without relying on ready-to-drive total vehicles.

### SUMMARY

Apparatus for applying force to a test object are disclosed, substantially as illustrated by and described in connection with at least one of the figures, as set forth more completely in the claims.

### BRIEF DESCRIPTION OF THE DRAWINGS

FIG. 1 shows a schematic, perspective view of an apparatus for introducing force into a test vehicle according to an embodiment of the present disclosure; and

FIG. 2 shows a schematic front view of the apparatus according to FIG. 1, without attachment anchors.

### DETAILED DESCRIPTION

Test benches simulate the loads acting on the chassis, body, and add-on parts during driving operation. Vertical movements caused by roadway imperfections, forces, torques, and movements generated by vehicle maneuvers are modeled as realistically as possible. Environmental factors such as temperature and corrosive effects can also be simulated in parallel. Active and adaptive chassis components can be integrated synchronously into the test procedure via corresponding interfaces of the test bench electronics.

The test benches known from the prior art differ, in particular, in the manner in which forces are introduced into the chassis, the body, and add-on parts. Thus, a first category of test benches is based on platforms on which one respective tire of the test vehicle is mounted. The platforms can be moved in multiple degrees of freedom in order to simulate loads in road operation. Other test benches use conveyor belts or roller conveyors in order to simulate the travel movement. Finally, there are test benches having wheel adapter elements, which are movable in the space by a plurality of linear drives. The wheel adapter elements serve as a simulation of the vehicle wheels used in the real world and are connected to the chassis of the test vehicle during the test so that the forces introduced into the wheel adapter element can be transmitted directly to the chassis of the test vehicle.

In the case of test benches known from the prior art having wheel adapter elements, it is possible to simulate substantially all forces that are to be expected in the activating operation. However, for example, the simulation of braking torques often results in the design of the test bench becoming complicated and expensive. Also, due to its construction, the introduction of rotational forces can lead to other forces, for example translational forces, not being able to be introduced into the wheel adapter element simultaneously.

Based on the aforementioned situation, the present disclosure addresses the problem of providing an apparatus for introducing force into a test vehicle that is as effective and cost-efficient as possible and can introduce the forces to be simulated as realistically as possible into the wheel adapter element and thus into the chassis, the body, and/or add-on parts.

This problem is solved in particular by the subject matter of independent claim 1. Advantageous further developments of the apparatus according to the disclosure are specified in the dependent claims 2 to 14.

Accordingly, the present disclosure relates to an apparatus for introducing force into a test vehicle, wherein the apparatus comprises the following: a wheel adapter element configured so as to be connected to a test vehicle; a first loading assembly for moving the wheel adapter element in a first, in particular translational, direction; a second loading assembly for moving the wheel adapter element in a second, in particular translational, direction, wherein the second direction extends substantially orthogonal to the first direction; a third loading assembly for moving the wheel adapter element in a third, in particular translational, direction, wherein the third direction extends substantially orthogonal to the first and second directions; a fourth loading assembly for rotating the wheel adapter element about a wheel axis, which extends parallel to the third direction; wherein the first, second, and third loading assemblies are connected to the wheel adapter element via a common three-joint node.

By introducing the torques for the translational movements via a three-joint node, the loads imparted in road operation can be simulated particularly realistically, because the forces/movements can be introduced in particular via a point (simulation of the contact point between the wheel and the road surface). At the same time, the separate, fourth loading assembly allows braking torques to be introduced directly into the test vehicle, without influencing the translational forces. In this way, particularly realistic activating situations can be easily simulated.

According to a further embodiment, the first loading assembly comprises a transfer element, which comprises a first end connected to the three-joint node and an opposing second end connected or connectable to a first actuator, wherein the fourth loading assembly comprises a first transfer element, which is arranged in particular parallel to the transfer element of the first loading assembly. As will be explained in greater detail below, due to the parallel arrangement of the transfer elements of the first and second loading assembly, it can be easily achieved that the fourth loading assembly can follow the movements introduced by the first to third loading assembly without restricting or blocking them. The fourth loading assembly can in particular be actuated separately.

According to a further embodiment, the first transfer element of the fourth loading assembly comprises a first end connected to an outer circumference of the wheel adapter element and an opposing second end connected or connectable to a fourth actuator. By attaching the first transfer element of the fourth loading assembly to the outer circumference of the wheel adapter element, braking torques can be particularly effectively introduced into the wheel adapter element. This can be done, for example, by a linear actuator which is connected to the second end of the transfer element of the fourth loading assembly.

According to a further embodiment, the transfer element of the first and/or fourth loading assembly is configured as a rod.

According to a further embodiment, the first loading assembly comprises a lever element, in particular an angle lever, arranged between the first actuator and the transfer element of the first loading assembly, wherein the lever element is pivotable about a first axis with the aid of the first actuator in order to move the wheel adapter element in the first direction.

According to a further embodiment, the fourth loading assembly comprises a first lever element, in particular a two-armed lever, which is arranged between the fourth actuator and the first transfer element of the fourth loading assembly, wherein the first lever element is pivotable about the first axis with the aid of the fourth actuator in order to rotate the wheel adapter element about the wheel axis. By arranging the first lever element of the fourth loading assembly and the lever element of the first loading assembly on the same (first) axis, a synchronization of the movement of the transfer elements of the first and fourth loading assembly along the first direction can be achieved. In other words, the transfer elements of the first and fourth loading assemblies move simultaneously in the vertical direction at all times, in particular upon activation of the actuator of the first loading assembly. By contrast, an activation of the fourth actuator will only result in movement of the transfer element of the fourth loading assembly, as will be explained in greater detail below.

According to a further embodiment, the lever element of the first loading assembly comprises a first lever arm connected or connectable to the first actuator and a second lever arm pivotally connected to the second end of the transfer element of the first loading assembly via a second axis, wherein the fourth loading assembly comprises a second lever element, in particular an angle lever, which is pivotable about the second axis. The kinematics of the first loading assembly are thus in communication with the kinematics of the second loading assembly at two axes.

According to a further embodiment, the first lever element of the fourth loading assembly comprises a first lever arm, which is connected or connectable to the fourth actuator, and a second lever arm connected to a first lever arm of the second lever element via a second transfer element. The aforementioned design of the first and second lever elements of the fourth loading assembly opposite the lever element of the first loading assembly generates a four-bar linkage, which ensures that the first transfer element of the fourth loading assembly is aligned parallel to the transfer element of the first loading assembly at all times.

According to a further embodiment, the second lever element of the fourth loading assembly comprises a second lever arm pivotally connected to the second end of the first transfer element of the fourth loading assembly.

According to a further embodiment, the transfer element of the first loading assembly is configured such that a longitudinal axis of the transfer element passes through a center point of the wheel adapter element, in particular in a resting position of the apparatus. In other words, the transfer element of the first loading assembly is located vertically below the wheel adapter element. Also during movement of the wheel adapter element, the transfer element of the first loading assembly is at all times substantially aligned in the direction of the center point of the wheel adapter element. This simulates a particularly realistic introduction of force into the wheel adapter element.

According to a further embodiment, the transfer element of the first loading assembly is configured as a single rod. The single rod extends between the three-joint node and the lever element of the first loading assembly parallel to a first transfer element of the fourth loading assembly, which element is preferably also configured as a rod. On the one hand, by configuring the first transfer element as a single rod, it can be achieved that the vertical forces (forces in a first direction) can be introduced into the wheel adapter element at one point in order to generate travel simulations that are as realistic as possible. On the other hand, this significantly simplifies the kinematics of the first loading assembly.

According to a further embodiment, the three-joint node is connected to a lower end region of the wheel adapter element. This allows all translational forces to be transmitted into the wheel adapter element simultaneously via a single point, namely the three-joint node. This corresponds particularly precisely to real driving conditions, because at all times the tires are only in contact with the roadway on their bottom side.

According to a further embodiment, the first and fourth loading assemblies are decoupled such that a movement of the wheel adapter element in the first direction is independent of a rotation of the wheel adapter element and vice versa.

According to a further embodiment, the first and fourth loading assembly comprises respective, separately controllable actuators, in particular linear actuators. Thus, it is possible at any time to introduce a braking torque either simultaneously to or separately from the translational movements generated with the first to third loading assemblies. Accordingly, the braking force introduction is completely independent of the translational movements generated by the first to third loading assemblies.

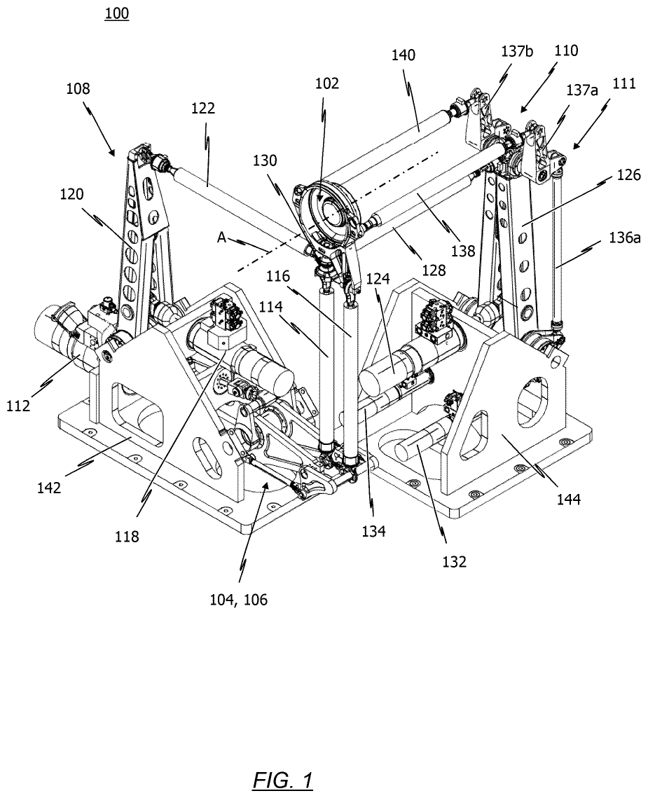

FIG. 1 is a perspective view of an apparatus for introducing force into a test vehicle according to an embodiment of the present disclosure. The apparatus 100 serves to move a wheel adapter element 102 in multiple degrees of freedom. In particular, the wheel adapter element 102 can be moved in six degrees of freedom by the apparatus 100.

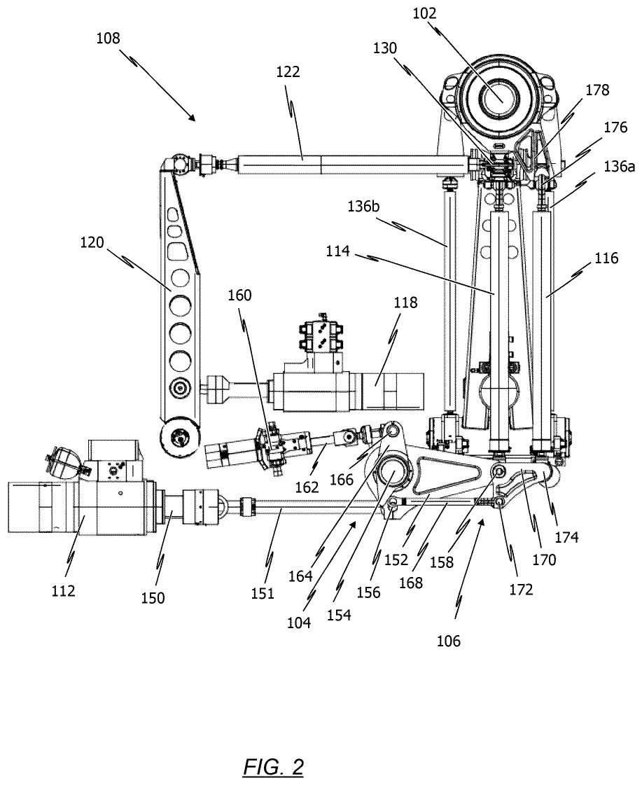

The apparatus 100 can be part of a test bench for simulating chassis loads while traveling. For example, such a test bench can contain four apparatuses according to FIG. 1, one apparatus per wheel of the test vehicle. In the following, only a single apparatus for introducing force is described on the basis of FIGS. 1 and 2. The function of the remaining apparatuses for introducing force is analogous. Of course, the activation of the actuators in the apparatus 100 of a test bench is synchronized with one another in order to create the desired load on the chassis of the test vehicle.

Although not shown in FIG. 1, when using the apparatus 100, the test vehicle is connected to the wheel adapter element 102. In particular, the chassis, for example the front or rear axis, is connected to the wheel adapter element 102 prior to the start of the test.

The apparatus 100 comprises a first loading assembly 104 for moving the wheel adapter element 102 in a first translational direction. In the embodiment shown herein, the first direction is the verticals.

The apparatus 100 further comprises a second loading assembly 108 for moving the wheel adapter element 102 in a second translational direction. In the embodiment illustrated herein, the second direction is a longitudinal direction that runs parallel to the longitudinal axis of the test vehicle during operation. Accordingly, the second translational direction runs substantially perpendicular to the first direction.

A third loading assembly 110 of the apparatus 100 for introducing force into a test vehicle is used in order to move the wheel adapter element 102 in a third translational direction. In the exemplary embodiment shown herein, the third direction is a lateral direction of movement. The third direction runs substantially perpendicular to the first and second directions. In summary, the first, second, and third loading assemblies 104, 108, 110 ensure that the wheel adapter element 102 is movable in all three translational directions of movement.

The apparatus 100 comprises a fourth loading assembly for rotating the wheel adapter element 102. In particular, the fourth loading assembly 106 can be used in order to rotate the wheel adapter element about the wheel axis A and thereby simulate a braking torque. The wheel axis A runs in particular parallel to the third direction. In the embodiment illustrated herein, the wheel axis A extends in the lateral direction.

The apparatus 100 further comprises a fifth loading assembly 111, which serves to introduce steering torques into the wheel adapter element 102. The steering torque is a rotation of the wheel adapter element 102 about a vertical axis (not shown) passing through the center point of the wheel adapter element 102 and intersecting the wheel axis A perpendicularly.

Also, by combining the third and fifth loading assemblies 110, 111, a pitching torque is introduced into the wheel adapter element 102. A pitching torque is a rotation of the wheel adapter element 102 about a transverse axis that runs perpendicular to the wheel axis A and the vertical axis (not shown) and parallel to the longitudinal axis of the test vehicle.

In the embodiment shown herein, the first, second, and fourth loading assemblies 104, 106, 108 are attached to a first anchor 142. The third and fifth loading assemblies 110, 111 are attached to a second anchor 144. For example, the anchors 142, 144 can be attached to a bottom plate in order to discharge the counterforces occurring during the test.

FIG. 2 is a front view of the apparatus 100 shown in FIG. 1, wherein, for the sake of readability, anchors 142, 144 are not shown. In particular, FIG. 2 shows that the first loading assembly 104 comprises a first actuator 112, in particular a linear drive. For example, the first actuator 112 can be configured as a hydraulic, electrical, or pneumatic linear drive.

The first actuator 112 comprises a drive rod 150 that is connected to a lever element 152 of the first loading assembly 104. In particular, the drive rod 150 is connected in an articulated manner with the lever element 152 via a coupling rod 151. The lever element 152 is configured as an angle lever in this example. The lever element 152 is pivotable about a first axis 154. The drive rod 150 is connected at its distal end to a hinged joint 156 of a first lever arm of the lever element 152. A second lever arm of the lever element 152 is connected via a hinged joint to a second end of a transfer element 114 of the first loading assembly 104. The hinged joint between the second lever arm of the lever element 152 and the transfer element 114 comprises a second pivot axis 158.

The transfer element 114 is in particular arranged between a three-joint node 130 and the second lever arm of the lever element 152. In the embodiment shown herein, the transfer element 114 is configured as a rod. The transfer element 114 is connected at its first end in an articulated manner with the three-joint node 130. In particular, the transfer element 114 can be connected to respective transfer elements 122, 128 of the second and third loading assemblies 108, 110 in the three-joint node 130 via a ball joint. At the opposite second end of the transfer element 114, it is connected in an articulated manner with the lever element 152, for example via the pivot axis 158. In this way, a movement of the first actuator 112 via the lever element 152 onto the transfer element 114 of the first loading assembly 104 can be transferred to the three-node joint 130 and the wheel adapter element 102 connected thereto, as will be further explained below.

FIG. 2 further illustrates an exemplary design of the fourth loading assembly 106. The fourth loading assembly 106 comprises a fourth actuator 160. The fourth actuator 160 is connected to a first lever element 164 of the fourth loading assembly 106 via the drive rod 162. In particular, a distal end of the drive rod 162 is connected to a first arm of the first lever element 164 via a pivot joint 166. Also, the first lever element 164 is pivotally arranged on the first axis 154. In other words, the first axis 154 is a common axis of the lever element 152 of the first loading assembly 104 and the first lever element 164 of the fourth loading assembly 106.

A second lever arm of the first lever element 164 of the fourth loading assembly 106 configured as a two-armed lever is connected in an articulated manner with a transfer element 168. The transfer element 168 connects the second lever arm of the first lever element 164 to a first lever arm of a second lever element 170 of the fourth loading assembly 106. The transfer element 168 is in particular pivotably connected to the second lever element 170 via a pivot joint 172. The second lever element 170 is pivotable about the second axis 158.

A second lever arm of the second lever element 170 configured as an angle lever is connected to a second end of a transfer element 116. In the embodiment illustrated herein, the transfer element 116 of the fourth loading assembly 106 is aligned parallel to the transfer element 114 of the first loading assembly 104. However, in other embodiments (not shown), the transfer element of the fourth loading assembly can also be aligned obliquely in relation to the transfer element of the first loading assembly.

A first end of the transfer element 116 is connected to a ball bearing 176. The ball bearing 176 communicates with an outer circumference of the wheel adapter element 102 via a bridge element 178. In other words, the transfer element 116 of the fourth loading assembly 106 is connected in an articulated manner with the outer circumference of the wheel adapter element 102 via its first end.

With the two common axes 154, 158 as well as the hinged joints 156, 172, a four-bar linkage is formed, which ensures that the second lever element 170 of the fourth loading assembly 106 maintains its orientation as shown in FIG. 2 when the transfer element 114 of the first loading assembly 104 is moved (vertically) via the lever element 152 in the first direction. In other words, the transfer element 116 of the fourth loading assembly moves upon activation of the first actuator 112 along with the first actuation element 114 of the first loading assembly. Thus, during activation of the first loading assembly, there is no relative movement between the actuating element 114 of the first loading assembly 104 and the first actuating element 116 of the second loading assembly 106.

The illustration according to FIG. 2 further shows an exemplary design of the second loading assembly 108. The second loading assembly 108 comprises a second actuator 118, which is connected to a transfer element 122 via a lever element 120. The lever element 120 is shown as a single-armed lever according to the embodiment shown herein, which can be pivoted by the drive rod of the second actuator 118. The transfer element 122 of the second loading assembly 108 is connected at a first end to the ball joint of the three-joint node 130. At an opposite second end, the transfer element 122 is connected in an articulated manner with a lever element 120.

In the initial position or resting position of the apparatus 100 as shown here, the transfer element 122 is aligned perpendicular to the transfer elements 114, 116 of the first and fourth loading assemblies, respectively. As mentioned above, the second loading assembly 108 is used in order to input movements in the longitudinal direction via the transfer element 122 that is aligned parallel to the longitudinal direction of the test vehicle. The transfer element 122 is also configured as a transfer rod (coupling rod).

Returning to FIG. 1, it should be noted that the third loading assembly 110 has a substantially identical design as the second loading assembly. However, the third loading assembly 110 is arranged at a 90° angle in relation to the second loading assembly 108.

The third loading assembly 110 comprises a third actuator 124 that is connected in an articulated manner with a transfer element 128 via a lever element 126. In the resting position of the apparatus 100 as shown in FIGS. 1 and 2, the transfer element 128 is arranged orthogonally to the transfer elements 114, 116, 122 of the first, second, and fourth loading assemblies. At a first end, the transfer element 128 of the third loading assembly 110 is also connected to the ball joint of the three-node joint 130. At a second, opposite end, the transfer element 128 is connected to the lever element 126. The lever element 126 is also configured as a single-armed lever in the embodiment shown herein.

Finally, FIGS. 1 and 2 also show a fifth loading assembly 111. The fifth loading assembly 111 comprises a fifth actuator 132 and a sixth actuator 134. The fifth actuator 132 is connected to a lever element 137a via a transfer element 136a. For example, the lever element 137a is configured as an angle lever. A second end of the lever element 137a is connected to a second transfer element 138. The second transfer element 138 of the fifth loading assembly 111 connects the lever element 137a to an outer circumference of the wheel adapter element 102.

The sixth actuator 134 is connected to a lever element 137b via a third transfer element 136b. For example, the lever element 137b is configured as an angle lever. A second end of the lever element 137b is connected to a fourth transfer element 140 of the fifth loading assembly. The second transfer element 140 of the fifth loading assembly 111 connects the lever element 137a to an outer circumference of the wheel adapter element 102.

In the embodiment shown here, the second and fourth transfer elements 138, 140 of the fifth loading assembly 111 run parallel to one another and parallel to the wheel axis A of the wheel adapter element 102. Alternatively, it is also contemplated to obliquely align the second and fourth transfer elements 138, 140 of the fifth loading assembly 111 in relation to one another. The two transfer elements 138, 140 are rod-shaped. The two transfer elements 138, 140 are each connected to the outer circumference of the wheel adapter element 102, in particular on diametrically opposed lateral faces of the wheel adapter element 102. Accordingly, by an opposite activation of the fifth and sixth actuators 132, 134 of the fifth loading assembly 111, a steering torque, that is to say a rotation about a vertical axis of the wheel adapter element 102, can be introduced into the wheel adapter element 102.

FIGS. 1 and 2 further illustrate that the three-joint node 130, in which the transfer elements 114, 122, 128 of the first, second, and third loading assemblies 104, 108, 110 are connected to one another, is arranged below the wheel element 102. The three-joint node 130 can accordingly be understood as a wheel mounting point of the wheel adapter element 102. The arrangement of the three-joint node 130 below the wheel adapter element 102 can simulate particularly realistic travel forces.

In operation, it is possible to introduce the aforementioned translational and rotational movements into the wheel adapter element 102 simultaneously and nevertheless independently of one another. The movement in the vertical direction (first direction) generated by the first loading assembly 104 as well as the rotation of the wheel element 102 about the wheel axis A with the aid of the fourth loading assembly 106 is discussed in greater detail below.

By activating the first actuator 112, a vertical movement of the transfer element 114 and correspondingly the wheel adapter element 102 can be achieved. In particular, by retracting the drive rod 150, a pivoting of the lever element 152 counterclockwise (as shown in FIG. 2) about the first axis 154 is achieved. Accordingly, the transfer element 114 of the first loading assembly 104 is moved in the direction of the wheel adapter element 102 (i.e., upwards). This vertical movement is transferred to the wheel adapter element 102 via the three-joint node.

Simultaneously with the vertical movement of the transfer element 114, the exemplary transfer element 116 of the fourth loading assembly 106 arranged parallel thereto is also moved upward. This is in particular the case because the second lever element 170 of the fourth loading assembly 106 is pivotally arranged on the second axis 158, i.e., the hinged joint of the transfer element 114 of the first loading assembly 104. Thus, the second lever element 170 is also pivoted counterclockwise when the lever element 152 of the first loading assembly 104 is moved. However, the aforementioned four-bar linkage ensures that the second lever element 170 is held in the orientation shown in FIG. 2 during the pivoting of the first lever element 152 of the first loading assembly 104. In other words, the superimposed kinematics between the first and fourth loading assemblies 104, 106 ensures that, upon activation of the first loading assembly 104, the movement of the transfer elements 114, 116 is synchronized with one another. There is no relative movement of the transfer elements 114, 116 with respect to one another as long as the fourth actuator 160 of the fourth loading assembly 106 is not activated.

Activation of the fourth actuator 160 of the fourth loading assembly 106 causes the second lever element 170 of the fourth loading assembly 106 to pivot relative to the lever element 152 of the first loading assembly 104. As a result, there is also a relative movement of the transfer element 116 of the fourth loading assembly 106 with respect to the transfer element 114 of the first loading assembly 104.

Specifically, by retracting the drive rod 162 of the fourth actuator 160, a rotation of the wheel adapter element 102 about the wheel axis A in the clockwise direction according to FIG. 2 can be achieved. To do this, the first lever element 164 is initially pivoted clockwise by drive rod 162 about the first axis 154. The second transfer element 168 of the fourth loading assembly 106 transfers this movement to the second lever element 170, which is thus likewise pivoted clockwise relative to the second axis 158 and thus relative to the lever element 152 of the first loading assembly 104, as shown in FIG. 2. Such a pivoting of the second lever element 170 clockwise according to FIG. 2 results in the first transfer element 116 of the fourth loading assembly being displaced in relation to the transfer element 114 of the first loading assembly 104. In this case, in particular, the transfer element 116 is pulled downwards in the illustration shown in FIG. 2 and transmits a torque to the wheel adapter element 102, in particular via the bridge element 178. The torque thus brought about causes a rotation of the wheel adapter element 102 in the clockwise direction according to FIG. 2. Such a rotation serves to simulate a braking force/braking movement of the vehicle.

On the one hand, the movement of the first and fourth loading assembly 104, 106 is synchronized with respect to vertical movements in the first direction. However, on the other hand, to introduce braking torques, the movement of the fourth loading assembly 160 is decoupled from the first loading assembly 104. In particular, by activating the fourth actuator 160, there can be a relative movement between the transfer elements 114 of the first loading assembly 104 and 116 of the second loading assembly 106 in order to introduce braking torques into the wheel adapter element 102 without needing a vertical movement at the same time.

The present disclosure is not limited to the embodiments presented in the figures, but rather results from a combination of all of the features disclosed herein.

What is claimed is:

1. An apparatus for introducing force in a test vehicle, wherein the apparatus comprises the following:
a wheel adapter element configured so as to be connected to a test vehicle;
a first loading assembly for moving the wheel adapter element in a first, in particular translational, direction;
a second loading assembly for moving the wheel adapter element in a second, in particular translational, direction, wherein the second direction extends substantially orthogonal to the first direction;
a third loading assembly for moving the wheel adapter element in a third, in particular translational, direction, wherein the third direction extends substantially orthogonal to the first and second directions;
a fourth loading assembly for rotating the wheel adapter element about a wheel axis (A), which extends parallel to the third direction,
wherein the first, second, and third loading assemblies are connected to the wheel adapter element via a common three-joint node.

2. The apparatus according to claim 1,
wherein the first loading assembly comprises a transfer element, which comprises a first end connected to the three-joint node and an opposing second end connected or connectable to a first actuator, and
wherein the fourth loading assembly comprises a first transfer element, which is arranged in particular parallel to the transfer element of the first loading assembly.

3. The apparatus according to claim 2, wherein the transfer element of the first loading assembly comprises at least one rod.

4. The apparatus according to claim 2, wherein the first transfer element of the fourth loading assembly comprises a first end connected to an outer circumference of the wheel adapter element and an opposing second end connected or connectable to a fourth actuator.

5. The apparatus according to claim 2, wherein the transfer element of at least one of the first loading assembly or the fourth loading assembly is configured as a rod.

6. The apparatus according to claim 2, wherein the first loading assembly comprises a lever element arranged between the first actuator and the transfer element of the first loading assembly, wherein the lever element is pivotable about a first axis with the aid of the first actuator in order to move the wheel adapter element in the first direction.

7. The apparatus according to claim 6, wherein the fourth loading assembly comprises a first lever element which is arranged between the fourth actuator and the first transfer element of the fourth loading assembly, wherein the first lever element is pivotable about the first axis with the aid of the fourth actuator in order to rotate the wheel adapter element about the wheel axis (A).

8. The apparatus according to claim 7,
wherein the lever element of the first loading assembly comprises a first lever arm connected or connectable to the first actuator and a second lever arm pivotally connected to the second end of the transfer element of the first loading assembly via a second axis, and
wherein the fourth loading assembly comprises a second lever element which is pivotable about the second axis.

9. The apparatus according to claim 8,
wherein the first lever element of the fourth loading assembly comprises a first lever arm, which is connected or connectable to the fourth actuator, and a second lever arm connected to a first lever arm of the second lever element via a second transfer element.

10. The apparatus according to claim 9, wherein the second lever element of the fourth loading assembly comprises a second lever arm pivotally connected to the second end of the first transfer element of the fourth loading assembly.

11. The apparatus according to claim 2, wherein the transfer element of the first loading assembly is configured such that a longitudinal axis of the transfer element passes through a center point of the wheel adapter element.

12. The apparatus according to claim 1, wherein the three-joint node is connected to a lower end region of the wheel adapter element.

13. The apparatus according to claim 1, wherein the first and fourth loading assemblies are decoupled such that a movement of the wheel adapter element in the first direction is independent of a rotation of the wheel adapter element and vice versa.

14. The apparatus according to claim 1, wherein the first and fourth loading assembly comprises respective, separately controllable actuators, in particular linear actuators.

15. A test bench for simulating forces and loads occurring in driving operation in a test vehicle, wherein the test bench comprises an apparatus according to claim 1 for each wheel of the test vehicle.
